(19) United States
(12) Patent Application Publication
(10) Pub. No.: US 2019/0377863 A1
(43) Pub. Date: Dec. 12, 2019

(54) PASSWORD INPUT METHOD, COMPUTER DEVICE AND STORAGE MEDIUM

(71) Applicant: PAX COMPUTER TECHNOLOGY (SHENZHEN) CO., LTD., Shenzhen (CN)

(72) Inventors: Ronghui ZHAO, Shenzhen (CN); Zhanqian YE, Shenzhen (CN)

(73) Assignee: PAX COMPUTER TECHNOLOGY (SHENZHEN) CO., LTD., Shenzhen (CN)

(21) Appl. No.: 16/463,530

(22) PCT Filed: Aug. 30, 2017
(86) PCT No.: PCT/CN2017/099581

§ 371 Date: May 23, 2019

(30) Foreign Application Priority Data
May 10, 2017 (CN) 201710327135.2

(51) Int. Cl. G06F 21/36

(52) U.S. Cl. CPC G06F 21/36; G06F 2221/031

(57) ABSTRACT

A password input method that includes calling a user space in an internal memory to obtain a password input request and to send the password input request to a security chip connected with the internal memory; calling the user space to receive random keyboard data generated by the security chip according to the password input request, and displaying a randomly arranged keyboard according to the random keyboard data; and calling a kernel space in the internal memory to obtain password coordinate data input through the keyboard and to send the password coordinate data to the security chip, so that the security chip generates a password plaintext of user input according to the password coordinate data and the random keyboard data.

### CROSS-REFERENCES TO RELATED APPLICATION

This application claims priority to Chinese Patent Application No. 201710327135.2, filed with the Chinese Patent Office on May 10, 2017 and entitled “PASSWORD INPUT METHOD, APPARATUS, COMPUTER DEVICE AND STORAGE MEDIUM”, which is incorporated herein by reference in its entirety.

### TECHNICAL FIELD

The present application relates to the field of information security technologies, and in particular, to a password input method, a computer device, and a storage medium.

### BACKGROUND

With the rapid development of Internet technology, more and more payment terminals (POS, Point of Sale) appear on the market. Payment terminals can be connected with smart devices such as mobile phones and tablet computers for data transmission. Payment terminals can complete operations such as card reading, personal identification number (PIN) input, data encryption and decryption, and prompt information display, thereby implementing the application of the payment function.

However, when the user performs a password input operation, the keyboard layout data generated by the terminal and the detected password coordinate data input by the user are directly stored in the kernel space in the internal memory. Therefore, it is equivalent to storing the password plaintext directly in the kernel space. When being hacked or being stolen by malware, it is easy to obtain the password plaintext directly from the kernel space. Therefore, the security of the password input is not high.

### SUMMARY

According to embodiments of the present application, a password input method, a computer device and a storage medium are provided.

A password input method, comprising: calling a user space in an internal memory to obtain a password input request and to send the password input request to a security chip connected with the internal memory; calling the user space to receive random keyboard data generated by the security chip according to the password input request, and displaying a randomly arranged keyboard according to the random keyboard data; and calling a kernel space in the internal memory to obtain password coordinate data input through the keyboard and to send the password coordinate data to the security chip, so that the security chip generates a password plaintext of user input according to the password coordinate data and the random keyboard data.

One or more non-volatile readable storage medium storing computer executable instructions, the computer executable instructions, when being executed by one or more processors, cause the one or more processors to perform following steps: calling a user space in an internal memory to obtain a password input request and to send the password input request to a security chip connected with the internal memory; calling the user space to receive random keyboard data generated by the security chip according to the password input request, and displaying a randomly arranged keyboard according to the random keyboard data; and calling a kernel space in the internal memory to obtain password coordinate data input through the keyboard and to send the password coordinate data to the security chip, so that the security chip generates a password plaintext of user input according to the password coordinate data and the random keyboard data.

A computer device comprising an internal memory, a security chip, a processor, and a program stored in the internal memory and executable in the processor, the internal memory comprising a user space and a kernel space, the processor is connected with the internal memory and the security chip through a system bus, the processor implements following steps when executing the program: calling the user space to obtain a password input request and to send the password input request to a security chip connected with the internal memory; calling the user space to receive random keyboard data generated by the security chip according to the password input request, and displaying a randomly arranged keyboard according to the random keyboard data; and calling the kernel space to obtain password coordinate data input through the keyboard and to send the password coordinate data to the security chip, so that the security chip generates a password plaintext of user input according to the password coordinate data and the random keyboard data.

Details of one or more embodiments of the present application are set forth in the accompanying drawings and description below. Other features and advantages of the present application will be apparent from the description, drawings and claims.

### DESCRIPTION OF THE DRAWINGS

In order to more clearly illustrate the technical solutions in the embodiments of the present application, the drawings to be used in the embodiments will be briefly described below. Obviously, the drawings in the following description are only some embodiments of the present application, those skilled in the art can also obtain other drawings based on these drawings without paying any creative work.

FIG. 1 is a diagram showing the internal structure of a computer device in an embodiment;

FIG. 2 is a flow chart of a password input method in an embodiment;

FIG. 3a is a schematic view of a normally arranged keyboard in one embodiment;

FIG. 3b is a schematic view of a randomly arranged keyboard in one embodiment;

FIG. 4 is a schematic view of a keyboard in another embodiment;

FIG. 5 is a comparison table of password coordinate data and random keyboard data in one embodiment;

FIG. 6 is a flow chart of obtaining password coordinate data in a kernel space in an embodiment;

FIG. 7 is a flow chart of ending the password input in one embodiment; and

FIG. 8 is a timing diagram of a password input method in one embodiment.

### DESCRIPTION OF THE EMBODIMENTS

In order to make the objects, technical solutions, and advantages of the present application more comprehensible, the present application will be further described in detail below with reference to the accompanying drawings and embodiments. It should be understood that the specific embodiments described herein are merely illustrative of the application and are not intended to limit the present application.

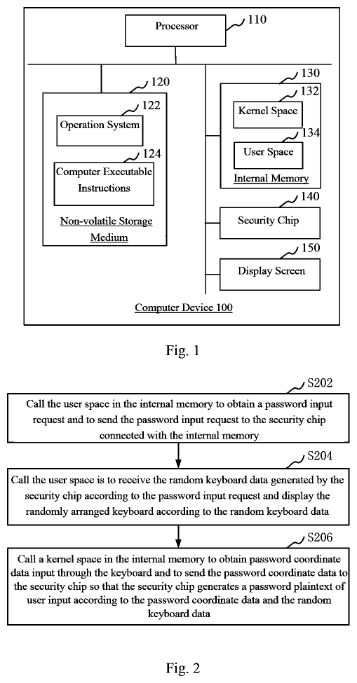

In one embodiment, as shown in FIG. 1, a computer device 100 is provided. Referring to FIG. 1, the computer device 100 includes a processor 110, a non-volatile storage medium 120, an internal memory 130, a security chip 140, and a display screen 150 which are connected through a system bus, and the security chip 140 and the internal memory 130 are connected to each other through hardware pins and a serial port. The processor 110 of the computer device 100 is configured to provide computing and control capabilities to support the operation of the entire computer device. The non-volatile storage medium 120 of the computer device 100 stores an operation system 122 and computer executable instructions 124 that are executable by the processor 110 for implementing one of password input methods in the following embodiments. The operating system 122 includes, but is not limited to, an Android system and/or a Linux system. The internal memory 130 provides a cached operating environment, including a kernel space 132 and a user space 134, for the operation system 122 and computer executable instructions 124 in the non-volatile storage medium 120. The kernel space 132 is used to store kernel code and data. The user space 134 is used to store code and data for the user program. The security chip 140 and the internal memory 130 are connected to each other by hardware. The security chip 140 may generate and process data related to implementing an above-mentioned password input method, such as generating random keyboard data, sending the random keyboard data to the user space 134, and parsing the subsequently obtained password coordinate data to generate a password plaintext and the like, and may send instructions related to an above-mentioned password input method, such as controlling the kernel space 132 to obtain the password coordinate data and the like. The display 150 of the computer device 100 may be a touch screen, such as a capacitive screen or an electronic screen, and may generate corresponding coordinate data by receiving a click operation on a keyboard displayed on the touch screen.

In an embodiment, the security chip 140 and the internal memory 130 are hardware-connected by a hardware pin and a pair of serial ports. In this embodiment, the hardware connection is simple, thereby saving cost, and expanding the application range of a password input method provided in the following embodiments.

In an embodiment, the kernel of the kernel space 132 may be verified by a signature.

It should be understood by those skilled in the art that the structure shown in FIG. 1 is only a block diagram of a part of the structure related to the solution of the present application and does not constitute a limitation to the computer device to which the solution of the present application is applied. The specific computer device may include more or fewer components than those shown in the figures, or combine some components, or have different component arrangements. For example, the computer device may further include a camera for scanning the user to perform identification verification on the user.

In an embodiment, as shown in FIG. 2, a password input method is provided. The method may be applied to the computer device 100 as shown in FIG. 1. The computer device 100 may be a terminal, including but not limited to a mobile phone, a tablet computer or a payment terminal, etc. The method includes:

Step S202, calling the user space in the internal memory to obtain a password input request and to send the password input request to the security chip connected with the internal memory.

In this embodiment, the user space refers to a memory space in the internal memory of the terminal for storing user program process data, and the user space cannot access data in the kernel space in the internal memory through a system call. The security chip is a trusted platform module, is a device that can independently perform key generation, encryption and decryption, and data verification, and has an independent processor and a storage unit inside that can store keys and feature data and provide encryption and security authentication service for the computer. The password input request is a request generated by the user space when a password input operation on the terminal is detected. The password input request operation may include, but is not limited to, powering on the terminal, the operation of causing the terminal to be unlocked from the screen-lock state so as to be switched to an application interface, the operation of entering the preset application, the operation requiring password input such as the preset payment operation or account transfer operation, and the like. After the user space is called to obtain the password input request, the password input request is sent to the security chip. Specifically, the password input request obtained by the user space according to the password input operation may be sent to the security chip through the serial port for connecting the internal memory with the security chip to call the password input interface of the security chip.

Further, the terminal may provide a corresponding password input interface for the operation correspondingly requiring password input, and the interface includes a corresponding control for entering the password input state. The above password input operation is a click operation on the control. When a click operation on the control is detected, the password input request is triggered, and after the password input request through the memory space is received, the password input request is sent to the security chip through the serial port.

In an embodiment, the operation requiring password input may be a payment operation, and when the user clicks the control on the terminal corresponding to payment operation, the user space may generate the password input request when detecting the click operation and send the password input request corresponding to the payment operation to the security chip.

In an embodiment, the terminal further includes a user identity information collection device, and after detecting a click operation applied to the control for entering the password input state, the preset user identity information may be collected by the user identity information collecting device and authenticated, if the authentication succeeds, the corresponding password input request is triggered. For example, the user may set the fingerprint as the user identity authentication information, and the user space generates the password input request after the preset fingerprint information input is received. For another example, the user may perform identity authentication through information transmission with the terminal by using identity identifier, such as placing a magnetic card with identity information close to the terminal to trigger the user space to generate the password input request through a near field wireless communication technology (NFC).

Step S204, calling the user space to receive the random keyboard data generated by the security chip according to the password input request and displaying the randomly arranged keyboard according to the random keyboard data.

In this embodiment, after receiving the password input request sent by the user space, the security chip may generate random keyboard data according to a preset random generation manner. The random keyboard data is data for displaying key values on a random arranged keyboard of the password input interface. The random keyboard data corresponds to the key coordinate data on the keyboard one by one. Specifically, the random keyboard data may include only ten digits 0 to 9, or only 26 English letters and ten digits, or 26 English letters, ten digits, and commonly used punctuation marks, and each digit, letter or mark appears only once. The preset random generation manner includes, but is not limited to, directly generating random keyboard data, or generating a sorting sequence of random keyboard data and generating random keyboard data according to the sorting sequence. Further, the user space may receive the random keyboard data sent by the security chip, and the terminal may read the random keyboard data stored in the user space and display a corresponding randomly arranged keyboard through the display screen, so that the user may input password by performing click operation on the keyboard. The key values of the randomly arranged keyboard correspond to the random keyboard data and may also include only ten digits 0 to 9, or only 26 English letters, or only 26 English letters and ten digits, or include 26 English letters, ten digits and commonly used punctuation marks.

In an embodiment, the random keyboard data only includes ten digits 1234567890. Random keyboard data 0836125974 may be directly generated; or the sorting sequence 0836125974 of the random keyboard data may be generated, and the initial 1234567890 is converted into random keyboard data according to the sorting sequence. In the converted random keyboard data, 1 is in the original 0 position, 2 is in the original 8 position. 3 is in the original 3 position, 4 is in the original 6 position, . . . 0 is in the original 4 position, and the converted random keyboard data is 563074921, and the random keyboard data generated each time may be used as the initial data for generating the random keyboard data next time.

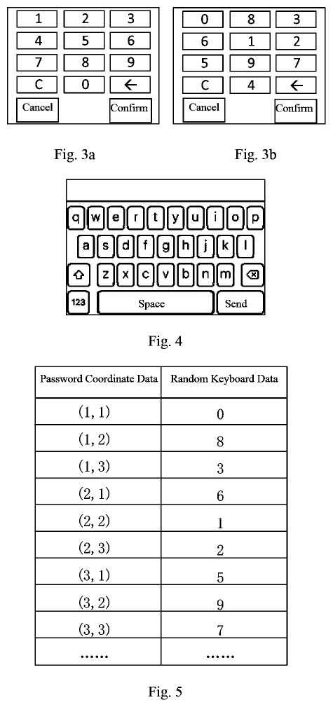

In an embodiment, the random keyboard data may be a sequence of digits containing only ten digits 0 to 9, and the key value of the corresponding randomly arranged keyboard also contains only ten digits 0 to 9. For example, a normal layout of the keyboard is shown in FIG. 3a, and each digit has its fixed corresponding position. If the user space receives the random keyboard data sent by the security chip, such as 0836125974, the generated randomly arranged keyboard is as shown in FIG. 3b, the key value corresponding to the original 1 position is 0, the key value corresponding to the original 2 position is 8, the key value corresponding to the original 3 position is 3, . . . , and the key value corresponding to the original 0 position is 4. The randomly arranged keyboard may also include fixed keys other than the key values corresponding to the random keyboard data, such as a clear key, a delete key, a cancel key, and a confirmation key.

In an embodiment, the layout type of the randomly arranged keyboard may be a full keyboard. As shown in FIG. 4, the key values of the keyboard keys may include 26 English letters, ten digits, and commonly used punctuation marks, etc., by clicking a switch key on the keyboard different types of keys may be displayed, and the keyboard also includes a case switch key, a delete key, a space bar, and a confirmation key. A particular keyboard may include more or fewer keys than shown, or combine some keys, or have different key arrangements. For example, the keyboard may not include a case switch key and a space bar.

Step S206, calling a kernel space in the internal memory to obtain password coordinate data input through the keyboard and to send the password coordinate data to the security chip, so that the security chip generates a password plaintext of user input according to the password coordinate data and the random keyboard data.

In this embodiment, the kernel space is a memory space in the internal memory for storing the system kernel. Among them, the system kernel is the core part of the operating system and is part of the software used to provide secure access to computer hardware for applications. The password coordinate data includes, but is not limited to, coordinate data corresponding to the touch or click position generated by a touch operation directly on the touch screen of the terminal or by a click operation performed on the screen keyboard by the mouse when the user performs the password input. In a randomly arranged keyboard, each key has its corresponding coordinate data, and the user may touch or click the key to select according to the displayed key value of the key. The password plaintext refers to the password data that the user actually inputs for password verification. Corresponding to the random keyboard data, the password plaintext may also include only ten digits 0 to 9, or only 26 English letters, or only 26 English letters and ten digits, or 26 English letters, ten digits and commonly used punctuation marks, etc. Specifically, in the security chip, a comparison table in which the password coordinate data and the random keyboard data are in one-to-one correspondence is stored. After receiving the password coordinate data sent by the kernel space through the serial port, the security chip may parse the password coordinate data according to the comparison table to obtain the password plaintext. In the embodiment, by configuring the corresponding security chip, the password plaintext is generated only in the security chip, and the random keyboard data and the password coordinate data generating the password plaintext are separately stored in the user space and the kernel space, so that the password plaintext cannot be directly obtained from any of the kernel space and the user space, which reduces the risk of the password plaintext being stolen, increases the difficulty of the password being cracked, and improves the security of the password input.

For example, when the generated randomly arranged keyboard is as shown in FIG. 3b, when the password input is performed, if the password 1234 is input, the coordinate data corresponding to the key 1 may be (2, 2), the coordinate data corresponding to the key 2 may be (3, 2), the coordinate data corresponding to the key 3 may be (3, 1), and the coordinate data corresponding to the key 4 may be (2, 4), and the password coordinate data obtained by kernel space may be (2, 2), (3, 2), (3, 1), (2, 4). As shown in FIG. 5, a comparison table of one-to-one correspondence between the password coordinate data and the random keyboard data is shown. When the password coordinate data received by the security chip is (3, 1), (2, 1), (3, 3), (1, 2), the comparison can be performed according to the comparison table, and it can be known that (3, 1) corresponds to 5, (2, 1) corresponds to 6, (3, 3) corresponds to 7, (1, 2) corresponds to 8, and the password plaintext corresponding to the password coordinate data can be parsed as 5678.

In one embodiment, the randomly arranged keyboard also includes a delete key and/or a clear key. If a touch or click operation performed on the delete key is received, the kernel space may be called to obtain the coordinate data corresponding to the delete key and send the coordinate data to the security chip and the security chip may parse the coordinate data and delete the corresponding digit from the password plaintext in the security chip. If there is no password plaintext in the security chip the delete operation cannot be performed. If a touch or click operation performed on the clear key is received, the kernel space may be called to obtain the coordinate data corresponding to the clear key and send the coordinate data to the security chip, and the security chip may parse the coordinate data and clear the password plaintext in the security chip.

In the above password input method, a user space is called to obtain a password input request and the password input request is sent to the security chip, the user space is called to receive random keyboard data generated by the security chip according to the password input request and a randomly arranged keyboard is displayed according to the random keyboard data, and a kernel space is called to obtain password coordinate data input by the user through the randomly arranged keyboard and to send the password coordinate data to the security chip, so that the security chip generates a password plaintext of user input according to the correspondence of the password coordinate data and the random keyboard. By configuring the corresponding security chip, the password plaintext is generated only in the security chip, and the random keyboard data and the password coordinate data generating the password plaintext are separately stored in the user space and the kernel space, so that the password plaintext cannot be obtained from any one of the kernel space and the user space, which reduces the risk of the password being hacked, increases the difficulty of the password being cracked, and improves the security of the password input.

In one embodiment, after calling the kernel space to obtain the password coordinate data input through the keyboard, the method further includes calling the kernel space to intercept the password coordinate data to be reported to the user space.

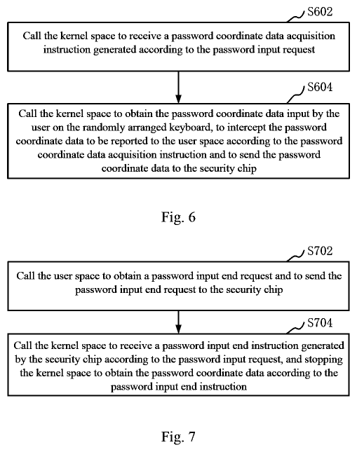

Specifically, as shown in FIG. 6, the process of intercepting the password coordinate data by the kernel space includes the following steps:

Step S602, calling the kernel space to receive a password coordinate data acquisition instruction generated according to the password input request.

In this embodiment, the password coordinate data acquisition instruction refers to an instruction generated by the security chip according to the received password input request, and is used to control the kernel space to obtain and intercept the password coordinate data input by the user on the randomly arranged keyboard. Specifically, the security chip may send the password coordinate data acquisition instruction through the hardware pin to manage the time when the kernel space obtains and intercepts the password coordinate data.

Step S604, calling the kernel space to obtain the password coordinate data input by the user on the randomly arranged keyboard, to intercept the password coordinate data to be reported to the user space according to the password coordinate data acquisition instruction and to send the password coordinate data to the security chip.

In this embodiment, after the kernel space is called to obtain the password coordinate data acquisition instruction, the kernel space may be called to obtain coordinate data corresponding to the touch or click position generated by a touch operation directly on the touch screen of the terminal or by a click operation performed on the screen keyboard by the mouse. The coordinate data includes but is not limited to password coordinate data. The password coordinate data refers to coordinate data generated by clicking or touching a key with a corresponding key value generated by random keyboard data on a randomly arranged keyboard when the user performs the password input. Further, the kernel space may be called to intercept the password coordinate data to be reported to the user space by the kernel space. For example, the password coordinate data may be intercepted by the drive code, and the password coordinate data may be sent to the security chip through the serial port, thereby avoiding the user space to obtain the password coordinate data.

In an embodiment, after the password coordinate data is sent to the security chip, the password input method further includes: generating, by the security chip, the password plaintext of user input according to the password coordinate data and the random keyboard data, converting the password plaintext into a password ciphertext, and sending the password ciphertext to the user space.

The password ciphertext may be the conversion data used for the next operation in the user space after the password is input, which can prevent the user space from directly obtaining the password plaintext for processing. Among them, the next operation includes but is not limited to password entry, password verification, and the like. Specifically, when the security chip receives the complete password coordinate data, for example, when the password coordinate data reaches a preset length, the security chip may encrypt the complete password coordinate data into a password ciphertext and send the password ciphertext to the user space through the serial port.

Further, the security chip may convert the password plaintext into a password ciphertext according to a preset encryption manner, where the preset encryption method includes but is not limited to one or a combination of a symmetric encryption algorithm such as Advanced Encryption Standard (AES), one-way hash algorithm such as Message Digest Algorithm MD5, a Password-Based Key Derivation Function 2 (PBKDF2) algorithm and the like. After generating the password ciphertext, the security chip sends the password ciphertext to the user space for the next operation.

For example, the security chip encrypts the password plaintext 1234 according to a preset Data Encryption Standard (DES) algorithm, and the generated password ciphertext, such as a ciphertext block (PINBLOCK), is abcd, and the security chip will send abcd to the user space for password verification. The verification password data preset by the user space is also a password ciphertext block generated by the same encryption method.

In the above embodiment, by converting the password ciphertext into the password ciphertext in the security chip according to the preset encryption method, and sending the ciphertext to the user space, the password plaintext only appears in the security chip, thereby improving the difficulty of stealing or cracking the password plaintext.

In an embodiment, as shown in FIG. 7, after the password coordinate data is sent to the security chip, the password input method further includes the step of ending the password input, and this step specifically includes:

Step S702, calling the user space to obtain a password input end request and to send the password input end request to the security chip.

In this embodiment, the password input end request may be a request generated by the user space in detecting a password input end operation of the user on the terminal. The password input end operation includes but is not limited to locking the screen of the terminal, clicking a corresponding key for ending password input, and the like. Among them, the key for ending the password input may be a confirm key or a cancel key. The password input end request may also be a request triggered when the length of the password input data reaches a preset password length, and the terminal does not need to provide a corresponding control, thereby saving the time of password input. After calling the user space to obtain the password input end request, the password input end request is sent to the security chip.

For example, the terminal may provide a corresponding key on the keyboard for ending the password input. When detecting a touch or click operation on the key, the terminal may trigger the password input end request, and when the user space is called to obtain the password input end request, the user space can send the password input end request to the security chip through the serial port. Alternatively, when the security chip receives the password coordinate data of the preset number of bits, it is considered that the user space sends an password input end request, for example, if the preset password length is four digits, when the security chip receives four password coordinate data, it is considered that the user space has sent an password input end request.

Step S704, calling the kernel space to receive a password input end instruction generated by the security chip according to the password input request, and stopping the kernel space to obtain the password coordinate data according to the password input end instruction.

In this embodiment, the password input end instruction is a corresponding instruction generated by the security chip after obtaining the password input end request. Further, the security chip may send the password input end instruction to the kernel space by setting a hardware pin, so that the kernel space stops obtaining the coordinate data. Specifically, before receiving the password input end instruction, the kernel space is called to obtain the coordinate data corresponding to the click or touch operation on the terminal in real time, and when the kernel space receives the password input end instruction, calling the kernel space to obtain the coordinate data is stopped.

In one embodiment, the randomly arranged keyboard also includes a fixed cancel key for ending password input. When a touch or click operation performed on the cancel key is detected, the kernel space may be called to obtain the coordinate data corresponding to the cancel key, the coordinate data is sent to the security chip, the security chip obtains the password input end request after parsing the coordinate data and sends the data corresponding to the cancel key to the user space and the user space may exit the password input state according to the data corresponding to the cancel key. For example, when a click operation on the cancel key on the password input interface is detected, the terminal will exit the interface.

In the above embodiment, by controlling, by the security chip, the kernel space to stop to obtain the password coordinate data, calling the kernel space to obtain unnecessary coordinate data after the password input of the user ends can be avoided, thereby saving resources and increasing the difficulty of tampering the input password coordinate data.

In an embodiment, after sending the password coordinate data to the security chip, the method further includes: calling the user space to receive the preset password display data sent by the security chip and displaying the password display data.

In this embodiment, the preset password display data is data used by the user space to display on the display screen of the terminal. The preset password display data may be a preset unified key value, such as “*”, or be an identifier generated, by the security chip, by conversion according to a key value of each input of the security chip in a preset method. Specifically, the security chip may send the preset password display data to the user space through the serial port, and each time the security chip receives a password coordinate data sent by the kernel space, the security chip sends a preset password display data to the user space for display. After the user touches or clicks a key on a randomly arranged keyboard, the corresponding amount of password display data is displayed on the display screen. For example, the security chip may send a unified key value “*” to the security chip, when the user inputs 1, the data displayed on the display screen is *, when the user inputs 1234, the data displayed on the display screen is ****.

In the above embodiment, by displaying the password display data sent by the security chip on the display screen, the risk of the password plaintext being peeped and used by others when the user password is entered is avoided, and the security of the password input is improved.

In one embodiment, the randomly arranged keyboard further includes a delete key and/or a clear key. If the delete key is touched or clicked, the data displayed on the display screen will be correspondingly decreased by corresponding number of digits. If the clear key is touched or clicked, the data displayed on the display screen will be cleared.

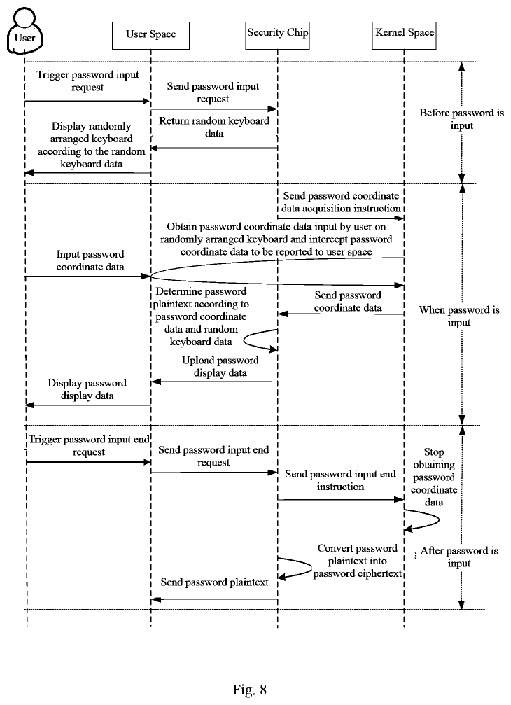

Preferably, as shown in FIG. 8, in one embodiment, a password entry method is provided. The password input method specifically includes the following process:

Before the password is input, the user triggers the password input request through the password input operation, the user space in the internal memory is called to obtain the password input request and the password input request is sent to the security chip connected to the memory. The random keyboard data generated by the security chip according to the password input request is received through the user space, and the randomly arranged keyboard is displayed according to the random keyboard data. Specifically, the password input request obtained by the user space is sent to the security chip through the serial port, and the random keyboard data generated by the security chip according to the password input request is returned to the user space through the serial port.

When the password is input, the kernel space in the internal memory is called to obtain the password coordinate data acquisition instruction generated by the security chip according to the password input request, the kernel space in the internal memory is called to obtain and intercept the password coordinate data input through the keyboard and to send the password coordinate data to the security chip, so that the security chip generates a password plaintext of user input according to the password coordinate data and the random keyboard data. Specifically, the password coordinate data acquisition instruction generated by the security chip is sent to the kernel space through a hardware pin. The security chip stores a comparison table composed of the password coordinate data and the random keyboard data, and the security chip may generate the password plaintext of user actual input according to the comparison table. Further, each time the security chip receives a password coordinate data, the user space is called to receive the preset password display data sent by the security chip, and the password display data is displayed. Specifically, the preset password display data in the security chip may be uploaded to the user space through the serial port, and the password display data received by the terminal may be displayed to the user through the display screen.

When the password input is completed, the user triggers the password input end request by the password input end operation, the user space is called to obtain the password input end request and send it to the security chip. The kernel space is called to receive password input end instruction generated by the security chip according to the password input request and stopped to obtain the password coordinate data according to the password input end instruction. Specifically, the password input end request obtained by the user space is sent to the security chip through the serial port, and the password input end instruction generated by the security chip is sent to the kernel space through the hardware pin. Further, the security chip generates a password plaintext of the user input according to the password coordinate data and the random keyboard data, converts the password plaintext into a password ciphertext, and sends the password ciphertext to the user space. Specifically, the password ciphertext generated by the security chip is sent to the user space through the serial port to perform the next operation.

In the above embodiment, by configuring the corresponding security chip, the password plaintext is generated only in the security chip, and the random keyboard data and the password coordinate data for generating the password plaintext are separately stored in the user space and the kernel space, so that the password plaintext cannot be obtained from any one of the kernel space and the user space, which reduces the risk of the password being hacked, increases the difficulty of the password being cracked. Moreover, by controlling, by the security chip, the time that the kernel space starts and stops to obtain the password data, the password data can be obtained timely and resource waste can be avoided. By displaying the password display data uploaded by the security chip to the user, the risk of the password plaintext being peeped and used by others when the user password is entered is avoided, and the security of the password input is improved.

One or more non-volatile readable storage medium storing computer executable instructions, the computer executable instructions, when being executed by one or more processors, cause the one or more processors to perform following steps: calling a user space in an internal memory to obtain a password input request and to send the password input request to a security chip connected with the internal memory; receiving, by the user space, random keyboard data generated by the security chip according to the password input request, and displaying a randomly arranged keyboard according to the random keyboard data; and calling a kernel space in the internal memory to obtain password coordinate data input through the keyboard and to send the password coordinate data to the security chip so that the security chip generates a password plaintext of user input according to the password coordinate data and the random keyboard data.

In an embodiment, after the program is executed by the one or more processors to call the kernel space in the internal memory to obtain the password coordinate data input through the keyboard, the following step is further implemented: calling the kernel space to intercept the password coordinate data to be reported to the user space.

In an embodiment, after the program is executed by the one or more processors to send the password coordinate data to the security chip, the following steps are further implemented: generating, by the security chip, the password plaintext of user input according to the password coordinate data and the random keyboard data, converting the password plaintext into a password ciphertext and sending the password ciphertext to the user space.

In an embodiment, after the program is executed by the one or more processors to send the password coordinate data to the security chip, the following steps are further implemented: calling the user space to obtain a password input end request and to send the password input end request to the security chip; and calling the kernel space to receive a password input end instruction generated by the security chip according to the password input request and stopping the kernel space to obtain the password coordinate data according to the password input end instruction.

In an embodiment, after the program is executed by the one or more processors to send the password coordinate data to the security chip, the following step is further implemented: calling the user space to receive preset password display data sent by the security chip and displaying the password display data.

In an embodiment, when the program is executed by the one or more processors, calling a user space in an internal memory to obtain a password input request and to send the password input request to a security chip connected with the internal memory includes calling the user space in the internal memory to obtain a password input request and to send, through the serial port, the password input request to the security chip connected with the internal memory; calling the user space to receive random keyboard data generated by the security chip according to the password input request, and displaying a randomly arranged keyboard according to the random keyboard data includes: calling the user space to receive, through the serial port, random keyboard data generated by the security chip according to the password input request and displaying a randomly arranged keyboard according to the random keyboard data, and calling a kernel space in the internal memory to obtain password coordinate data input through the keyboard and to send the password coordinate data to the security chip, so that the security chip generates a password plaintext of user input according to the password coordinate data and the random keyboard includes calling, through a hardware pin, a kernel space in the internal memory to obtain password coordinate data input through the keyboard and to send, through a serial port, the password coordinate data to the security chip, so that the security chip generates a password plaintext of user input according to the password coordinate data and the random keyboard data.

A computer device comprising an internal memory, a security chip, a processor, and a program stored in the internal memory and executable in the processor, the internal memory comprising a user space and a kernel space, the processor is connected with the internal memory and the security chip through a system bus, the processor implements following steps when executing the program: calling the user space to obtain a password input request and to send the password input request to a security chip connected with the internal memory; receiving, by the user space, random keyboard data generated by the security chip according to the password input request, and displaying a randomly arranged keyboard according to the random keyboard data; and calling the kernel space to obtain password coordinate data input through the keyboard and to send the password coordinate data to the security chip, so that the security chip generates a password plaintext of user input according to the password coordinate data and the random keyboard data.

In one embodiment, after the processor executes the program to implement the step of calling the kernel space in the internal memory to obtain the password coordinate data input through the keyboard, the following step is further implemented: calling the kernel space to intercept the password coordinate data to be reported to the user space.

In an embodiment, after the processor executes the program to implement the step of sending the password coordinate data to the security chip, the following steps are further implemented: generating, by the security chip, the password plaintext of user input according to the password coordinate data and the random keyboard data, converting the password plaintext into a password ciphertext and sending the password ciphertext to the user space.

In an embodiment, after the processor executes the program to implement the step of sending the password coordinate data to the security chip, the following steps are further implemented: calling the user space to obtain a password input end request and to send the password input end request to the security chip; and calling the kernel space to receive a password input end instruction generated by the security chip according to the password input request and stopping the kernel space to obtain the password coordinate data according to the password input end instruction.

In an embodiment, after the processor executes the program to implement the step of sending the password coordinate data to the security chip, the following step is further implemented: calling the user space to receive preset password display data sent by the security chip and displaying the password display data.

In an embodiment, when the processor executes the program, calling a user space in an internal memory to obtain a password input request and to send the password input request to a security chip connected with the internal memory includes calling the user space in the internal memory to obtain a password input request and to send, through the serial port, the password input request to the security chip connected with the internal memory; calling the user space to receive random keyboard data generated by the security chip according to the password input request, and displaying a randomly arranged keyboard according to the random keyboard data includes: calling the user space to receive, through the serial port, random keyboard data generated by the security chip according to the password input request and displaying a randomly arranged keyboard according to the random keyboard data, and calling a kernel space in the internal memory to obtain password coordinate data input through the keyboard and to send the password coordinate data to the security chip, so that the security chip generates a password plaintext of user input according to the password coordinate data and the random keyboard includes calling, through a hardware pin, a kernel space in the internal memory to obtain password coordinate data input through the keyboard and to send, through a serial port, the password coordinate data to the security chip, so that the security chip generates a password plaintext of user input according to the password coordinate data and the random keyboard data.

One of ordinary skill in the art can understand that all or part of the process of implementing the above embodiments may be completed by using a computer program to instruct related hardware, and the program may be stored in a non-volatile computer readable storage medium, when the program is executed, the flow of method embodiments as described above may be included. The storage medium may be a magnetic disk, an optical disk, a read-only memory (ROM), or the like.

The technical features of the above-described embodiments may be arbitrarily combined. For the sake of brevity of description, not all possible combinations of the technical features in the above embodiments are described. However, as long as there is no contradiction in the combinations of these technical features, all should be considered in the scope of this specification.

The above-mentioned embodiments are merely illustrative of several embodiments of the present application, and the description thereof is specific and detailed, but should not be construed as limiting the scope of the application. It should be noted that a number of variations and modifications may be made by those skilled in the art without departing from the spirit and scope of the present application. Therefore, the scope of the application should be determined by the appended claims.

1-20. (canceled)

21. A password input method, comprising:
calling a user space in an internal memory to obtain a password input request and to send the password input request to a security chip connected with the internal memory;
calling the user space to receive random keyboard data generated by the security chip according to the password input request, and displaying a randomly arranged keyboard according to the random keyboard data; and
calling a kernel space in the internal memory to obtain password coordinate data input through the keyboard and to send the password coordinate data to the security chip, so that the security chip generates a password plaintext of user input according to the password coordinate data and the random keyboard data.

22. The password input method according to claim 21, wherein after said calling a kernel space in the internal memory to obtain password coordinate data input through the keyboard, the method further comprises:
calling the kernel space to intercept the password coordinate data to be reported to the user space.

23. The password input method according to claim 21, wherein after said sending the password coordinate data to the security chip, the method further comprises:
generating, by the security chip, the password plaintext of user input according to the password coordinate data and the random keyboard data, converting the password plaintext into a password ciphertext, and sending the password ciphertext to the user space.

24. The password input method according to claim 21, wherein after said sending the password coordinate data to the security chip, the method further comprises:
calling the user space to obtain a password input end request and to send the password input end request to the security chip; and
calling the kernel space to receive a password input end instruction generated by the security chip according to the password input request and stopping the kernel space to obtain the password coordinate data according to the password input end instruction.

25. The password input method according to claim 21, wherein after said sending the password coordinate data to the security chip, the method further comprises:
calling the user space to receive preset password display data sent by the security chip and displaying the password display data.

26. The password input method according to claim 21, wherein the internal memory is connected with the security chip through a hardware pin and a serial port;
said calling a user space in an internal memory to obtain a password input request and to send the password input request to a security chip connected with the internal memory comprising:
calling the user space in the internal memory to obtain a password input request and to send, through the serial port, the password input request to the security chip connected with the internal memory;
said calling the user space to receive random keyboard data generated by the security chip according to the password input request and displaying a randomly arranged keyboard according to the random keyboard data comprising:
calling the user space to receive, through the serial port, random keyboard data generated by the security chip according to the password input request and displaying a randomly arranged keyboard according to the random keyboard data;
said calling a kernel space in the internal memory to obtain password coordinate data input through the keyboard and to send the password coordinate data to the security chip so that the security chip generates a password plaintext of user input according to the password coordinate data and the random keyboard data comprising:
calling, through a hardware pin, a kernel space in the internal memory to obtain password coordinate data input through the keyboard and to send, through a serial port, the password coordinate data to the security chip so that the security chip generates a password plaintext of user input according to the password coordinate data and the random keyboard data.

27. One or more non-volatile readable storage mediums storing computer executable instructions, the computer executable instructions, when being executed by one or more processors, causing the one or more processors to perform following steps:
calling a user space in an internal memory to obtain a password input request and to send the password input request to a security chip connected with the internal memory;
calling the user space to receive random keyboard data generated by the security chip according to the password input request, and displaying a randomly arranged keyboard according to the random keyboard data; and
calling a kernel space in the internal memory to obtain password coordinate data input through the keyboard and to send the password coordinate data to the security chip so that the security chip generates a password plaintext of user input according to the password coordinate data and the random keyboard data.

28. The computer readable storage medium according to claim 27, further comprising, after said step of calling a kernel space in the internal memory to obtain password coordinate data input through the keyboard:
calling the kernel space to intercept the password coordinate data to be reported to the user space.

29. The computer readable storage medium according to claim 27, further comprising, after said step of sending the password coordinate data to the security chip:
generating, by the security chip, the password plaintext of user input according to the password coordinate data and the random keyboard data, converting the password plaintext into a password ciphertext, and sending the password ciphertext to the user space.

30. The computer readable storage medium according to claim 27, further comprising, after said step of sending the password coordinate data to the security chip:
calling the user space to obtain a password input end request and to send the password input end request to the security chip; and
calling the kernel space to receive a password input end instruction generated by the security chip according to the password input request and stopping the kernel space to obtain the password coordinate data according to the password input end instruction.

31. The computer readable storage medium according to claim 27, further comprising, after said step of sending the password coordinate data to the security chip:
calling the user space to receive preset password display data sent by the security chip and displaying the password display data.

32. The computer readable storage medium according to claim 27, wherein the internal memory is connected with the security chip through a hardware pin and a serial port;
said calling a user space in an internal memory to obtain a password input request and to send the password input request to a security chip connected with the internal memory comprising:
calling the user space in the internal memory to obtain a password input request and to send, through the serial port, the password input request to the security chip connected with the internal memory;
said calling the user space to receive random keyboard data generated by the security chip according to the password input request, and displaying a randomly arranged keyboard according to the random keyboard data comprising:
calling the user space to receive, through the serial port, random keyboard data generated by the security chip according to the password input request and displaying a randomly arranged keyboard according to the random keyboard data;
said calling a kernel space in the internal memory to obtain password coordinate data input through the keyboard and to send the password coordinate data to the security chip, so that the security chip generates a password plaintext of user input according to the password coordinate data and the random keyboard data comprising:
calling, through a hardware pin, a kernel space in the internal memory to obtain password coordinate data input through the keyboard and to send, through a serial port, the password coordinate data to the security chip, so that the security chip generates a password plaintext of user input according to the password coordinate data and the random keyboard data.

33. A computer device comprising an internal memory, a security chip, a processor, and a program stored in the internal memory and executable in the processor, the internal memory comprising a user space and a kernel space, the processor is connected with the internal memory and the security chip through a system bus, the processor implements following steps when executing the program:
calling the user space to obtain a password input request and to send the password input request to a security chip connected with the internal memory;
calling the user space to receive random keyboard data generated by the security chip according to the password input request, and displaying a randomly arranged keyboard according to the random keyboard data; and
calling the kernel space to obtain password coordinate data input through the keyboard and to send the password coordinate data to the security chip, so that the security chip generates a password plaintext of user input according to the password coordinate data and the random keyboard data.

34. The computer device according to claim 33, wherein after said calling a kernel space in the internal memory to obtain password coordinate data input through the keyboard, the method further comprises:
calling the kernel space to intercept the password coordinate data to be reported to the user space.

35. The computer device according to claim 33, wherein after said sending the password coordinate data to the security chip, the method further comprises:
generating, by the security chip, the password plaintext of user input according to the password coordinate data and the random keyboard data, converting the password plaintext into a password ciphertext, and sending the password ciphertext to the user space.

36. The computer device according to claim 33, wherein after said sending the password coordinate data to the security chip, the method further comprises:
calling the user space to obtain a password input end request and to send the password input end request to the security chip; and
calling the kernel space to receive a password input end instruction generated by the security chip according to the password input request and stopping the kernel space to obtain the password coordinate data according to the password input end instruction.

37. The computer device according to claim 33, wherein after said sending the password coordinate data to the security chip, the method further comprises:
calling the user space to receive preset password display data sent by the security chip and displaying the password display data.

38. The computer device according to claim 33, wherein the internal memory is connected with the security chip through a hardware pin and a serial port;
said calling a user space in an internal memory to obtain a password input request and to send the password input request to a security chip connected with the internal memory comprising:
calling the user space in the internal memory to obtain a password input request and to send, through the serial port, the password input request to the security chip connected with the internal memory;
said calling the user space to receive random keyboard data generated by the security chip according to the password input request, and displaying a randomly arranged keyboard according to the random keyboard data comprising:
calling the user space to receive, through the serial port, random keyboard data generated by the security chip according to the password input request and displaying a randomly arranged keyboard according to the random keyboard data;
said calling a kernel space in the internal memory to obtain password coordinate data input through the keyboard and to send the password coordinate data to the security chip, so that the security chip generates a password plaintext of user input according to the password coordinate data and the random keyboard data comprising:
calling, through a hardware pin, a kernel space in the internal memory to obtain password coordinate data input through the keyboard and to send, through a serial port, the password coordinate data to the security chip, so that the security chip generates a password plaintext of user input according to the password coordinate data and the random keyboard data.

39. The computer device according to claim 33, wherein the internal memory is hardware-connected with the security chip through a hardware pin and a pair of serial ports.

40. The computer device according to claim 33, wherein a kernel in the kernel space is verified by signature.
